(19) United States
(12) Patent Application Publication
(10) Pub. No.: US 2006/0070285 A1
(43) Pub. Date: Apr. 6, 2006

(54) Beam signage and communication system

(76) Inventor: Dean Grant, Mississauga (CA)

Correspondence Address: MILLER THOMPSON, LLP, 20 QUEEN STREET WEST, SUITE 2500, TORONTO, ON, M5H 3S1, CA

(21) Appl. No.: 11/206,270

(22) Filed: Aug. 18, 2005

Related U.S. Application Data
(60) Provisional application No. 60/602,324, filed on Aug. 18, 2004.

(51) Int. Cl. G09F 3/20

(52) U.S. Cl. 40/651; 40/611.06

(57) ABSTRACT

A beam signage and communication system for a display or storage structure, which includes a bracket shaped to the display or storage structure that may have attachment zones. The attachment zones may be angled to allow for improved visibility. The beam signage and communication system may further include at least two positioning channels that may be spaced apart and are parallel to one another. The two positioning channel may be mounted to the bracket at the angled attachment zones. The beam signage and communication system may also include a changeable communication means supported between the two positioning channels only by the weight of the changeable communication means thereby allowing the changeable communication means to be viewed at an angle.

### FIELD OF THE INVENTION

This invention relates in general to a system for displaying signs and more particularly to a beam signage and communication system having enhanced graphic flexibility and is mounted on display or storage structures and has a variety of configurations.

### BACKGROUND OF THE INVENTION

Signage and/or point of purchase displays are used throughout the retail business to ensure consumer awareness of a product. A wide variety of signage is available, such as active signs, which have moving display cases, animation and static signs which are the most common as they mount to some portion of a shelf or rack and are relatively economical. The proper display or storage of the relevant product in close proximity to the signage is crucial to ensure that the consumer is first of all aware of the product and secondly to encourage the consumer to purchase the product. Inaccurate signage and the inability to locate the product in association with the signage can mean that the consumer will not bother purchasing the product and frustrating the consumer.

The majority of displays in retail settings are custom designed and made for a particular customer or purpose. Product samples are often loosely displayed, easily removed or lost, or permanently attached to the displays, thereby making it more difficult to make changes to the display when the product assortment changes. There are very few systems available, which allow the retailer to efficiently display product samples that are difficult to remove by the customer but are easy to change out when changes to the product assortment are required. Similar problems are found with signage systems that include copy or graphics advertising the product. Typically changes to copy or graphics in signage require that the entire sign must be redone.

Furthermore, many existing displays are permanently attached to the racking or display or storage (often sticking out in the aisle), making access to stock behind the sign impossible or difficult without damaging the display. Many displays are also not durable or flexible enough to withstand harsh retail environments and thus sustain permanent damage from lift trucks, customers removing product, etc. As a result, replacement costs for signage can often be high.

There are few systems available that have the versatility to mount in various positions on the racking/display or storage, can adjust to changing graphics and do not intrude into the aisle. Most of the existing designs have been purposely built for a particular retailer, manufacturer, product or need. There has been limited development of large-scale display signage systems that adapt to various programs or store environments as well as changing graphics especially in the home improvement store environment.

A large portion of the existing display holders can not be easily modified at the store level to allow for increases or decreases in product assortment, or changing graphics. The existing ones often require special tools or newly designed parts for modification. Furthermore existing display holders often do not allow for the easy interchanging of graphics by the retailer and require the retailers to reprint the signage.

Prior art display devices have been devised to address only some of the aforenoted problems associated with display devices. For example, U.S. Pat. No. 5,924,367 issued on Jul. 20, 1999 to Henke et al. relates to a shelf sign system comprising a first shelf and a second shelf. A first mounting bracket is attached to the first shelf and attached to the second shelf. The first mounting bracket spans the first shelf and the second shelf, and a rotatable sign unit engages with the mounting bracket and can move from a closed position to a locked position.

U.S. Pat. No. 5,860,537 which issued on Jan. 19, 1999 and U.S. Pat. No. 6,234,329 B1 which issued on May 22, 2001 both relate to a storage and sales unit having a storage space and a display space. It also includes a frame receivable of a display element and movable between a first position in which access to the storage space is prevented, and a lockable second position enabling access to the storage space, while the display space is continually accessible. The frame is pivotally mounted to the storage and sale unit such that that the frame is pivotable about a first pivot axis between the first and second positions.

U.S. Pat. No. 5,934,633 which issued on Aug. 10, 1999 to Padiak et al. relates to a sign mounting system for pivotally mounting a sign to an associated storage rack includes a bracket having substantially vertical and horizontal legs contiguous with one another, and a mounting arm pivotally mounted to the bracket by a pivot pin.

However, the prior art display devices do not address a beam signage and communication system that is easy to install, allows for lateral movement of graphics as well as easy removal of graphics in large scale for the home improvement store environment. Most prior art display devices also only move between a hanging down position in which the signage is visible yet at an awkward angle and a locked up position in which the signage is not visible. Moreover, the prior art devices only allow for the display of signage and not product samples, are difficult to manipulate and can not be customized to create a wide variety of signage display systems. Most display devices also require that the graphic or signage be supported or requires additional structure such as backing or foam board so that the graphic is visible when incorporated into the display device. Thus, a beam signage and communication system which may be customized to a wide variety of positions and combinations while maintaining the easy and comfortable visibility of the signage, is easy to construct, manipulate and does not require additional structure is desirable.

### SUMMARY OF THE INVENTION

An object of one aspect of the present invention is to provide an improved beam signage and communication system that allows for improved visibility of signage while allowing customized displays that can include product samples and graphics, which are easy to construct and manipulate.

In accordance with one aspect of the present invention there is provided a beam signage and communication system for a display or storage structure, which includes a bracket shaped to the display or storage structure that may have attachment zones. The attachment zones may be angled to allow for improved visibility. The beam signage and communication system may further include at least two positioning channels that may be spaced apart and are parallel to one another. The two positioning channel may be mounted to the bracket at the angled attachment zones. The beam signage and communication system may also include a changeable communication means supported between the two positioning channels only by the weight of the changeable communication means thereby allowing the changeable communication means to be viewed at an angle.

Preferably the changeable communication means is at least one flexible graphic having either a flat, a convex or a concave profile and has various attachment zones at different angles to accommodate a wide range of positioning to make viewing the communication system convenient and easy to read. Conveniently the positioning channels may have a variety of different profiles to accommodate creating different beam signage and communication systems. By using a system of extruded shapes the instant invention can accommodate a wide range of graphics or samples in various positions above, on and below the beams and shelves in a retail store.

Advantages of the present invention are: holds large scale graphics/samples in any configuration thereby making changes easy and more cost effective; provides a durable structure with minimal aisle intrusion to protect graphics/samples from harsh environments; allows graphics/samples to be displayed at angles for best readability/viewing by customers; allows access to product behind the display without damaging the display; available in any length and many heights; and can be attached to racking/display or storage in many configurations for maximum flexibility and use of retail space; positioning channels hold the material either securely so it can not be removed or loosely so that it is easy to change out as new stock becomes available; the system assembles with a screwdriver, drill and hand saw, all commonly available at the store; at a store level, the staff can combine various components of the system and create a custom display from a few inches long to hundreds of feet; the capability of the system also allows the displays to be mounted on several shelves/beams in the same linear section therefore increasing the communication to the customer by up to several hundred percent depending on the number of shelves involved; and graphics can be produced in small sections and mounted into the system, enabling changes to graphics to be done at a lower cost.

### BRIEF DESCRIPTION OF THE DRAWINGS

A detailed description of the preferred embodiments are provided herein below by way of example only and with reference to the following drawings, in which:

FIG. 1A is a side view, of the positioning channel in accordance with a preferred embodiment of the present invention;

FIG. 1B is a side view, of the positioning channel in accordance with a preferred embodiment of the present invention;

FIG. 1C is a side view, of the positioning channel in accordance with a preferred embodiment of the present invention;

FIG. 1D is a side view, of the positioning channel in accordance with a preferred embodiment of the present invention;

FIG. 1E is a side view, of the positioning channel in accordance with a preferred embodiment of the present invention;

FIG. 2 is a side view, of a preferred embodiment in accordance with the present invention;

FIG. 3 is a perspective view, of a preferred embodiment in accordance with the present invention;

FIG. 4 is a side view, of the preferred embodiment in accordance with the present invention;

FIG. 5 is a side view, of the preferred embodiment in accordance with the present invention;

FIG. 6 is a side view, of the preferred embodiment in accordance with the present invention;

FIG. 7 is a side view, of the preferred embodiment in accordance with the present invention;

FIG. 8 is a side view, of the preferred embodiment in accordance with the present invention;

FIG. 9 is a side view, of the preferred embodiment in accordance with the present invention;

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

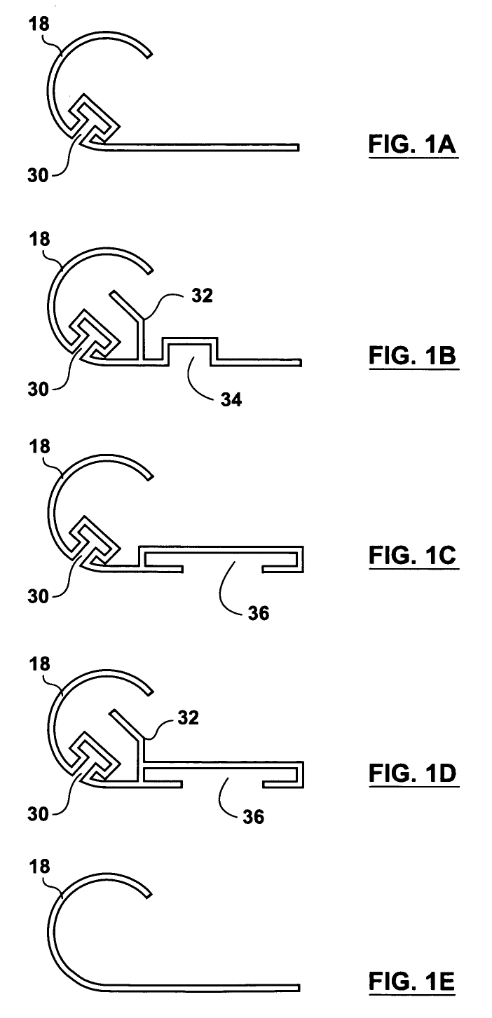

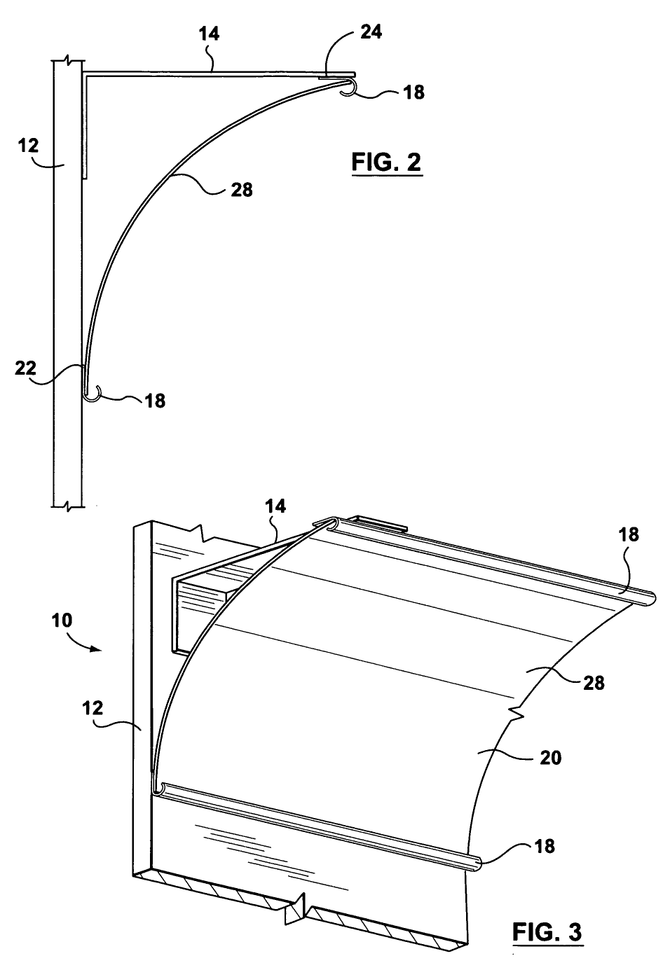

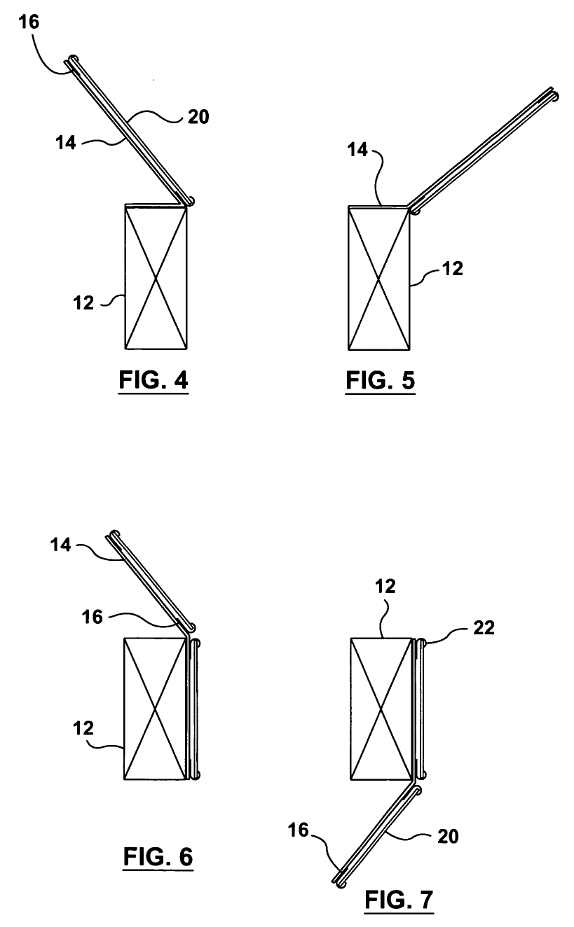

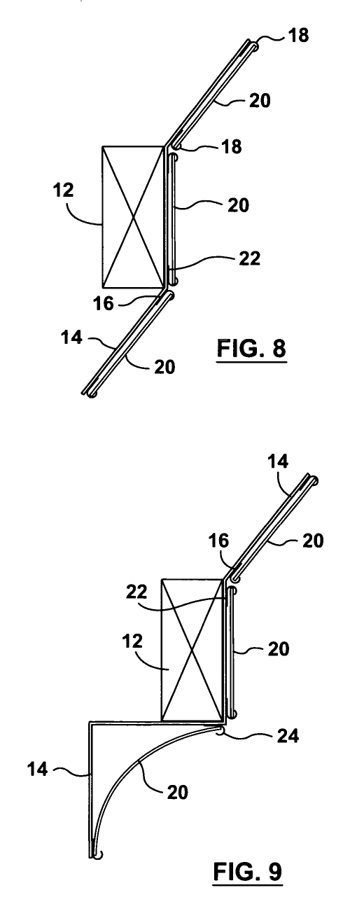

Referring to FIGS. 1-9 there is illustrated a beam signage and communication system 10 for a display or storage structure 12 in accordance with a preferred embodiment of the present invention. The beam signage and communication system 10 for a display or storage structure 12 includes a least one bracket 14 shaped to the display or storage structure 12 that has attachment zones 16, at least two positioning channels 18 and a changeable communication means 20. The attachment zones 16 may be angled 16, along a vertical 22 or a horizontal 24. The brackets 14 may be mounted to the display or storage structure 12 a variety of ways including traditional fastening mechanisms.

The beam signage and communication system 10 may further include at least two positioning channels 18 that may be spaced apart and are parallel to one another. The two positioning channels 18 may be mounted to the bracket 14 at the angled attachment zones 16, the vertical attachment zones 22 or the horizontal attachment zones 24. Depending on the configuration of the bracket 14 there can be multiple positioning channels 18 mounted at various attachment zones 16, 22 and 24. The positioning channels 18 may have a variety of profiles as illustrated in FIGS. 1A-1E. The positioning channels 18 may be J-shaped and include a T-shaped slot 30. The T-shaped slot 30 is adapted to receive a connector (not shown) that could potentially mate two positioning channels 18 having the same T-shaped slot 30 together. The positioning channels 18 may further include a retaining wall 32. The retaining wall 32 may help position or seat the changeable communication means 20. The positioning channels 18 may be mounted to the bracket 14 a variety of ways. The bracket 14 may also be mounted so as to be movable along the display or storage structure 12 and may be positioned inwards relative the changeable communication means 20 as illustrated in FIG. 3. More specifically the J-shaped positioning channels 18 may have holes (not shown) to accept fasteners such as a bolt. The positioning channels 18 may also include various shaped slots, either square shaped 34 or rectangular shaped 36 that mate with respective protrusions (not shown) on the bracket 14. In operation, the positioning channel 18 may be slid on to the respective protrusions of the bracket 14 thereby securing the positioning channel 18 to the bracket 14. The positioning channels 18 may be made from a variety of material, such as a variety of metals and plastics or wood. The instant invention does not require that the positioning channels 18 have end caps thereby allowing for easy access for assembling and inserting said changeable communication means 20.

The beam signage and communication system 10 may also include a changeable communication means 20 that is supported between the two positioning channels 18 only by the weight of the changeable communication means 20 thereby allowing the changeable communication means 20 to be viewed at an angle when the positioning channels 18 are mounted at the angled attachment zones 16. The changeable communication means 20 may be further defined as at least one flexible graphic 26 having a concave profile 28, a flat profile or a convex profile. The flexible graphic 26 may be made from a variety of materials or may be sandwiched between two thin pieces of clear plastic. Specifically the flexible graphic 26 is supported between the two positioning channels 18 and the concave profile 28 is maintained only by the weight of the flexible graphic 26.

Traditionally a graphic that is mounted on a display or storage structure requires additional support such as some sort of backing or cardboard. The instant invention does not require additional support, but relies only upon its own weight to provide support and better positioning thereby providing improved visibility at an angle.

The instant invention provides for improvements with respect to durability, logistics, graphic potential and flexibility, economy, quality of graphic content and can be adapted to work with traditional overhead signage. More specifically the instant invention has improved durability as the flexible graphic 26 can be made from high-impact plastic that bounces back from impact. The individual components of the instant invention can also be shipped separately and flat yet be assembled in minutes to improve logistics. The positioning of the flexible graphic 26 namely the mounting to angled attachment zones 16 along with the concave profile 28 provides far greater visibility for customers than traditional vertical overhead signs. This improvement in turn provides for more descriptive copy opportunities, more variety with the inclusion of photography and more information thereby allowing for consumers to make more informed purchasing decisions.

Graphics 26 can be presented continuously and seamlessly over a variety of lengths of positioning channels 18, thereby providing clearer communications and greater opportunities for graphic 26 alignment and adjacencies to the actual product that the graphic 26 is advertising. Specifically the flexible graphic 26 permits lateral, side-by-side graphic modularity thereby allowing a high level of flexibility for tailoring different stores and different regional advertising requirements, as well as reusing graphics or economically producing site-specific graphics. Finally the increased economics of the instant invention allows for the use of more expensive quality of graphics such as four-colour lithography.

Other variations and modifications of the invention are possible. All such modifications or variations are believed to be within the sphere and scope of the invention as defined by the claims appended hereto.

1. A beam signage and communication system for a shelving structure comprising:
(a) a bracket shaped to said shelving structure having attachment zones wherein said attachment zones are angled;
(b) at least two positioning channels spaced apart and parallel from one another mounted to said bracket at said angled attachment zones;
(c) a changeable communication means supported between said two positioning channels only by the weight of said changeable communication means allowing for viewing said changeable communication means at an angle.

2. A beam signage and communication system for a shelving structure as claimed in claim 1 wherein said changeable communication means is at least one flexible graphic having a concave profile.

3. A beam signage and communication system for a shelving structure as claimed in claim 2 wherein said attachment zones further comprise vertical attachment zones for attachment of said positioning channels and said flexible graphic.

4. A beam signage and communication system for a shelving structure as claimed in claim 3 wherein said attachment zones further comprise horizontal attachment zones for attachment of said positioning channels and said flexible graphic.

5. A beam signage and communication system for a shelving structure as claimed in claim 4 wherein said positioning channels are J-shaped.

6. A beam signage and communication system for a shelving structure as claimed in claim 5 wherein said positioning channels further comprise a T-shaped slot.

7. A beam signage and communication system for a shelving structure as claimed in claim 6 wherein said T-shaped slot is adapted to receive a connector for connecting one positioning channel to another.

8. A beam signage and communication system for a shelving structure as claimed in claim 5 wherein said positioning channels further comprise a retaining wall.

9. A beam signage and communication system for a shelving structure as claimed in claim 2 wherein said bracket is mounted to said shelving structure by a fastening means.

10. A beam signage and communication system for a shelving structure as claimed in claim 6 wherein said positioning channels further comprise a square shaped mounting slot.

11. A beam signage and communication system for a shelving structure as claimed in claim 10 further comprising a square shaped protrusion on said bracket adapted to mate with said square shaped mounting slot.

12. A beam signage and communication system for a shelving structure as claimed in claim 11 wherein said positioning channels further comprise a retaining wall.

13. A beam signage and communication system for a shelving structure as claimed in claim 6 wherein said positioning channel further comprises a rectangular shaped mounting slot.

14. A beam signage and communication system for a shelving structure as claimed in claim 13 further comprising a rectangular shaped mounting protrusion on said bracket adapted to mate with said rectangular shaped mounting slot.

15. A beam signage and communication system for a shelving structure as claimed in claim 14 wherein said positioning channel further comprises a retaining wall.

16. A beam signage and communication system for a shelving structure as claimed in claim 2 wherein said flexible graphic can slide laterally along said positioning channels making said flexible graphics changeable.

17. A beam signage and communication system for a shelving structure as claimed in claim 2 wherein said flexible graphic is positioned between thin clear plastic sheets.

18. A beam signage and communication system for a shelving structure as claimed in claim 9 wherein said fastening means is a bolt assembly.

19. A beam signage and communication system for a shelving structure as claimed in claim 1 wherein said changeable communication means is at least one flexible graphic having a convex profile.

20. A beam signage and communication system for a shelving structure as claimed in claim 1 wherein said changeable communication means is at least one flexible graphic having a flat profile.
